(19) United States
(12) Patent Application Publication
(10) Pub. No.: US 2002/0072375 A1
(43) Pub. Date: Jun. 13, 2002

(54) Apparatus, system and method for allocating upstream and downstream channels in a cellular communication system having a wireless backhaul

(76) Inventor: Daniel J. huslig, San Diego, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/993,021

(22) Filed: Nov. 13, 2001

Related U.S. Application Data
(60) Provisional application No. 60/248,377, filed on Nov. 13, 2000.

(51) Int. Cl. H04Q 7/20

(52) U.S. Cl. 455/455; 455/445

(57) ABSTRACT

Downstream link signals are transmitted between a base station and a distribution station within an upstream frequency bandwidth allocated to the cellular system for upstream communication for mobile stations. Upstream link signals are transmitted between the distribution station and the base station within a downstream frequency bandwidth allocated to the cellular system for upstream communication for mobile stations. The distribution station frequency shifts the downstream link signals from the upstream frequency bandwidth to a downstream coverage frequency within the downstream frequency bandwidth and frequency shifts upstream coverage signals from the upstream frequency bandwidth to an upstream link frequency within the downstream frequency bandwidth. Interception and interference of link signals is reduced since the mobile stations do not receive signals within the upstream frequency bandwidth or transmit signals within the downstream frequency bandwidth.

### RELATED APPLICATION

This application claims priority to U.S. Provisional Patent Application No. 60/248,377, entitled “SWAPPING UPLINK AND DOWNLINK FREQUENCIES BETWEEN REPEATER INTERFACE AND REPEATER”, filed on Nov. 13, 2000; and is incorporated herein in its entirety.

### BACKGROUND OF THE INVENTION

The invention relates in general to wireless communication and more specifically to allocating upstream and downstream channels in a cellular communication system having a wireless backhaul.

Cellular communication systems provide wireless service to mobile stations using base stations where each base station provides service to mobile stations within a cell corresponding to the particular base station. Frequency bandwidth is distributed between the base stations allowing for frequency re-use in cells that are spaced at a sufficient distance. In many cellular systems, the base station communicates directly with mobile stations within the cell using the coverage frequencies assigned to the cell. Systems in accordance with the description in U.S. Pat. No. 5,787,344 issued to Stefan Scheinert on Jul. 28, 1998, entitled “Arrangement of Base Transceiver Stations of an Area-Covering Network”, however, provide service to mobile stations through clusters of distribution stations connected through a wireless backhaul. In such systems, a base interface station connected to the base station communicates with the base station using coverage frequencies while communicating with the distribution stations using link frequencies. In some implementations, the link channels at the link frequencies are within frequency bandwidths assigned to the base station for communication with mobile stations and are often referred to as “in-band”.

In accordance with the procedures and protocols of the cellular system and network, the mobile stations establish communication by responding to information forwarded or initiated from the base station. In systems using the in-band link channels, certain situations may occur where the mobile units will attempt to communicate on the link channel. Therefore, there is need for an apparatus, system and method for efficiently allocating link channels and coverage channels in a cellular communication system with a wireless backhaul.

### BRIEF DESCRIPTION OF THE DRAWINGS

FIG. 1 is block diagram of a cellular communication system using a wireless backhaul in accordance with an exemplary embodiment of the invention.

FIG. 2 is a graphical representation of a frequency spectrum including the upstream frequency bandwidth and the downstream frequency bandwidth in accordance with the exemplary embodiment of the invention.

FIG. 3 is a block diagram of a base interface station in accordance with the exemplary embodiment of the invention.

FIG. 4 is a block diagram of a distribution station in accordance with the exemplary embodiment of the invention.

FIG. 5 is a block diagram of a downstream frequency shifter in accordance with exemplary embodiment of the invention suitable for use within the interface station and the distribution station.

FIG. 6 is a block diagram of an upstream frequency shifter suitable for use in the distribution station and the interface station.

FIG. 7 is a flow chart of a method of communicating between the base station and a mobile station in accordance with the exemplary embodiment of the invention.

FIG. 8 is flow chart of a method of communicating between a cellular base station and a distribution station in accordance with the exemplary embodiment of the invention.

### DETAILED DESCRIPTION OF THE PREFERRED EMBODIMENTS

In an exemplary embodiment of the invention, a base station communicates with one or more distribution stations using link channels where the frequency of the downstream link channel is within an upstream frequency bandwidth of the cellular system and the upstream link channel is within a downstream frequency bandwidth of the cellular system.

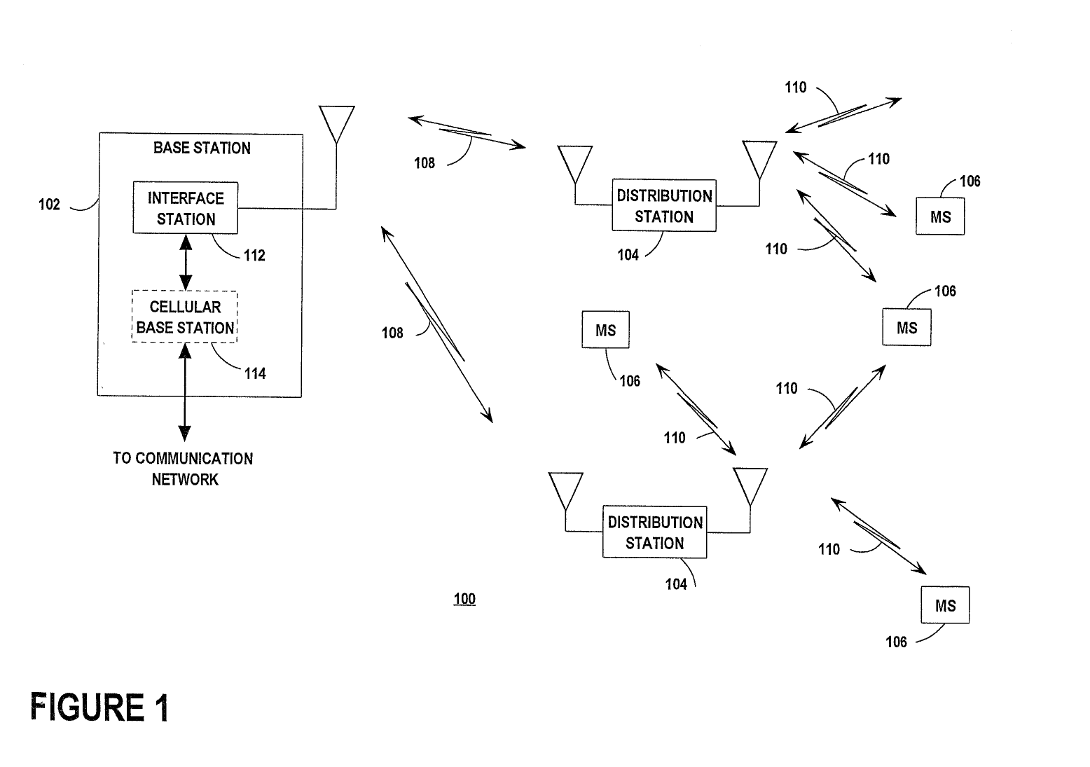

FIG. 1 is a block diagram of a wireless communication system 100 in accordance with the exemplary embodiment of the invention. The base station 102 communicates through a link channel 108 with the distribution stations 104 using link signals while corresponding coverage signals are exchanged through a coverage channel 110 between the distribution stations 104 and the mobile stations 106. In the exemplary embodiment, the base station 102 transmits a downstream link signal at a downstream link frequency to one or more distribution stations 104 within a cluster through the link channel 108. The distribution stations 104 frequency shift the downstream link signal to a downstream coverage frequency to form a downstream coverage signal. Each of the distribution stations 104 within the cluster transmits the downstream coverage signal to mobile stations 106 within the service area of a cluster. Therefore, in the exemplary embodiment, the cluster of distribution stations 104 simulcast the downstream coverage signal to the mobile stations 106 within the service area of the cluster. Those skilled in the art will recognize that where multiple versions of the downstream coverage signal are transmitted to a mobile station 106, the wireless coverage channel 110 has similar characteristics to a wireless channel experiencing reflection, interface and fading.

In the upstream direction, the one or more distribution stations 104 receive an upstream coverage signal transmitted from a mobile station 106 at an upstream coverage frequency. The distribution stations 104 frequency shift the upstream coverage signal to an upstream link frequency and transmit the resulting upstream link signal to the base station 102. Multiple distribution stations 104 may receive the upstream coverage signal from a particular mobile station 106 and transmit corresponding upstream link signals to the base station 102. The link channel 108, therefore, may contain multiple versions of an upstream link signal. Those skilled in the art will recognize that the resulting upstream link channel has characteristics similar to a multipath wireless channel where multiple versions of a signal are received through the channel.

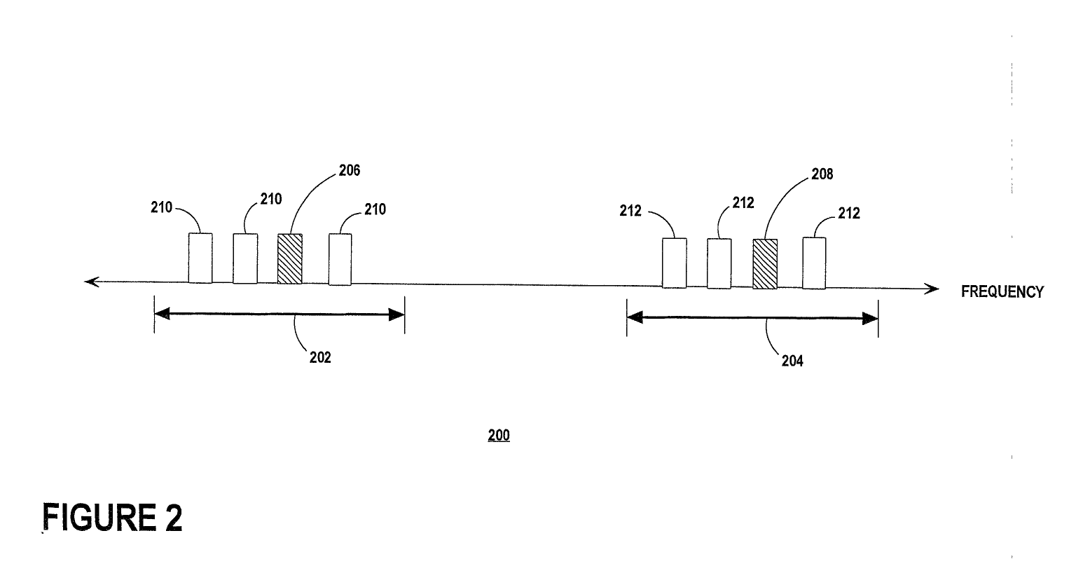

The link channel 108 includes a downstream link channel at the downstream link frequency and an upstream link channel at the upstream link frequency. As explained below in further detail with reference to FIG. 2, the downstream link channel is within the upstream frequency bandwidth assigned to the base station 102 and the upstream link channel is within the downstream frequency bandwidth assigned to the base station 102.

Although the present invention maybe utilized in accordance with a variety of communication systems, modulation techniques, and protocols, the wireless communication system 100 is implemented as part of a GSM cellular system in the exemplary embodiment. The communication system 100 includes at least one base station 102, and one distribution station 104. In the exemplary embodiment, a geographic region is divided into cells where a single base station 102 provides wireless service to mobile stations 106 within a cell through clusters of distribution stations 104 located within the cell. Examples of implementations of cellular systems having a wireless backhaul are discussed in detail in U.S. Pat. No. 5,787,344 issued to Stefan Scheinert on Jul. 28, 1998, entitled “Arrangement of Base Transceiver Stations of an Area-Covering Network” and which is incorporated by reference herein.

In the exemplary embodiment, the interface station 112 is connected to a cellular base station 114 that is part of a conventional GSM cellular system to form the base station 102. The base station 102 is connected to a communication network that includes various networks and systems such as other parts of the cellular system and a Public Switched Telephone Network (PSTN). The base station exchanges data, control and other information with the appropriate components of the communication network. Components of the cellular system such as base station controllers, switches and Operation and Maintenance Centers (OMC) provide the necessary management and control in accordance with known techniques.

The cellular base station 114 is shown as a block having a dashed line to illustrate that the base station 102 may be single integrated unit. Therefore, the cellular base station 114 may be a separate device from the interface station 112 or the base station 102 may be a single integrated unit having the functionality of the interface station 112 and the cellular base station 114 as described herein. The cellular base station 114 is likely to be separate from the interface station 112 where a simulcast communication system with distribution stations 104 is integrated with an existing cellular infrastructure and the interface station 112 is connected to an existing cellular base station 114. Those skilled in the art, however, will recognize the various suitable configurations of the interface station 112 and the cellular base station 114 and implementations of the base station 102 in accordance with the teachings herein. For example, the functionality of the interface station 112 can be implemented in a cellular base station 114 by modifying a conventional cellular base station or manufacturing an integrated base station that functions as both a cellular base station 114 and an interface station 112. Further, the interface station 112 and the cellular base station 114 can be co-located or can be in different locations. In the exemplary embodiment, the interface station 112 is connected to the cellular base station 114 through a coaxial cable. Communication and control signals, however, can be transmitted between the two units (112, 114) using a cable, radio frequency link, microwave link or any other type of wired or wireless communication channel.

Each cellular base station 114 communicates over a coaxial cable with the corresponding interface station 112 using a set of communication frequencies allocated to the base station coverage region of the base station 102. The interface station 112 communicates with several distribution stations 104 within a sector over the link channel 108 using a the pair of link frequencies. The base station coverage regions of the base station 102 are partitioned into sectors, where a dedicated set of frequencies is used for communicating with mobile stations 104 within the sector. A suitable frequency allocation plan within a cellular system includes partitioning the base station coverage region into three sectors and dedicating four frequencies within a downstream frequency bandwidth and four frequencies within an upstream frequency bandwidth per sector. Time division multiplexing (TDM) techniques are used to provide eight time slots per frequency where at least one time slot within a sector is reserved for control and system management functions. Each of the distribution stations 104 within a particular sector uses the set of coverage frequencies (coverage channels) allocated to the particular sector to communicate with one or more mobile stations 104 over the coverage channel 110. In the exemplary embodiment, wireless service is not provided directly by the base station 102 to the mobile stations 106. Those skilled in the art will recognize that the frequency allocation scheme may be modified to meet the requirements of a particular base station coverage area or system 100.

FIG. 2 is graphical representation of a frequency spectrum 200 in accordance with the exemplary embodiment of the invention. A downstream frequency bandwidth 202 and an upstream frequency bandwidth 204 are assigned to the base station 102 and the wireless communication system 100. The frequency bandwidths (202,204) are typically authorized for use by a licensing authority such as the FCC (Federal Communication Commission). In the exemplary embodiment, eight channels (or frequency bands) 206-212 are allocated to a sector of a base station coverage region of the base station 102 where four of the channels 206, 210 have frequencies within the downstream frequency bandwidth 202 and four channels 208, 212 have frequencies within the upstream frequency bandwidth 204. Each channel can be interpreted as a frequency or set of frequencies within a band limited section of frequency spectrum 200. The blocks representing the channels (206-212) in FIG. 2, therefore, also represent a frequency or set of frequencies corresponding to the frequency or frequencies used for transmission through the channel. For example, in the exemplary embodiment, a frequency modulated carrier signal at an appropriate carrier frequency allows for transmission through a channel (206-212).

Although the frequency bandwidths 202, 204 are shown as sections of continuous frequency spectrum in FIG. 2, one or both of the frequency bandwidths (202, 204) may be discontinuous and may include sections of spectrum separated by frequencies that are not authorized for use by the wireless communication system 100. Further, the various channels (206-212) may have variety of arrangements within the particular frequency bandwidth 202, 204. For example, two or more of the channels (206-212) may be adjacent to each other or may be separated by only a guard-band. The channels (206-212) may or may not be evenly spaced within the particular frequency bandwidth (202, 204). Also, the upstream frequency bandwidth 204 may be higher or lower than the downstream frequency bandwidth 202 in frequency.

The downstream frequency bandwidth 202 includes downstream coverage channels 210 and an upstream link channel 206 and the upstream frequency bandwidth 204 includes upstream coverage channels 212 and a downstream link channel. Although there are three coverage channels (three coverage frequencies) and one link channel (link frequency) within each frequency bandwidth 202, 204 in the exemplary embodiment, the frequency bandwidths 202, 204 may include any number of coverage or link channels.

In the exemplary embodiment, each upstream coverage channel 212 (upstream coverage frequency) is uniquely associated with a downstream coverage channel 212 (downstream coverage frequency) to form a coverage channel pair (coverage frequency pair) that is used for communication through the coverage channel 110. The upstream coverage channel 210 is separated from the downstream coverage channel 212 of each coverage channel pair by a constant frequency difference in the exemplary embodiment. The upstream link channel 206 is separated from the downstream link channel of a link channel pair by the same frequency difference. Other frequency separations between the channels (206-212), however, can be used. For example, in situations where each frequency bandwidth 202, 204 includes more than one link channel (206, 208), the upstream link channels 206 may be associated with downstream link channels 208 such that the frequency difference is not the same as within the coverage channel pairs.

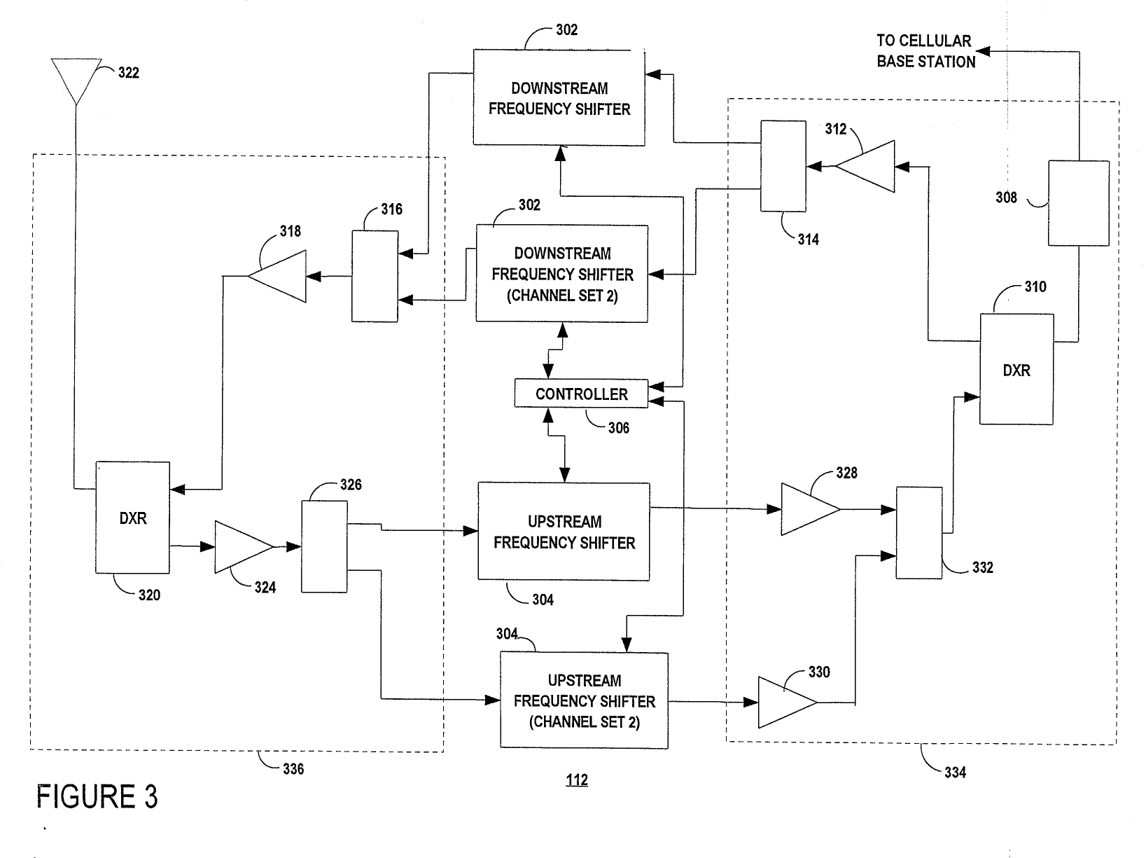

FIG. 3 is a block diagram of a interface station 112 in accordance with the exemplary embodiment of the invention. The functional blocks in FIG. 3 may be implemented using any combination of hardware, software or firmware. The interface station 112 in the exemplary embodiment is configured to receive two downstream signals at two different frequencies and to transmit corresponding downstream signals at two distribution frequencies. FIG. 3 illustrates blocks for receiving and processing signals at two frequencies. Similar functional blocks for processing other signals at other frequencies can be connected to the blocks shown using splitters and combiners. The teachings herein can be expanded to implement a interface station 112 capable of processing any number of signals or channels.

The interface station 112 includes at least a base communication interface 334 for communicating with the cellular base station 114 and a link communication interface 336 for with the distribution station 104. The functions of the communication interfaces 334-336 can be implemented using any combination of software, hardware and firmware. Exemplary implementations are discussed below. The blocks representing the communication interfaces 334-336 are shown using dashed lines to indicate that each of the communication interfaces (334-336) may include other functional blocks or portions of function blocks shown in FIG. 3. For example, some or all of the communication interfaces 334-336 may include portions of the frequency shifters 302, 304 or the controller 306.

The base interface station 112 includes a downstream frequency shifter 302 for each downstream channel to frequency shift an incoming downstream coverage signal to the downstream distribution frequency. An upstream frequency shifter 304 frequency shifts the upstream distribution signal to the upstream coverage frequency for each upstream channel.

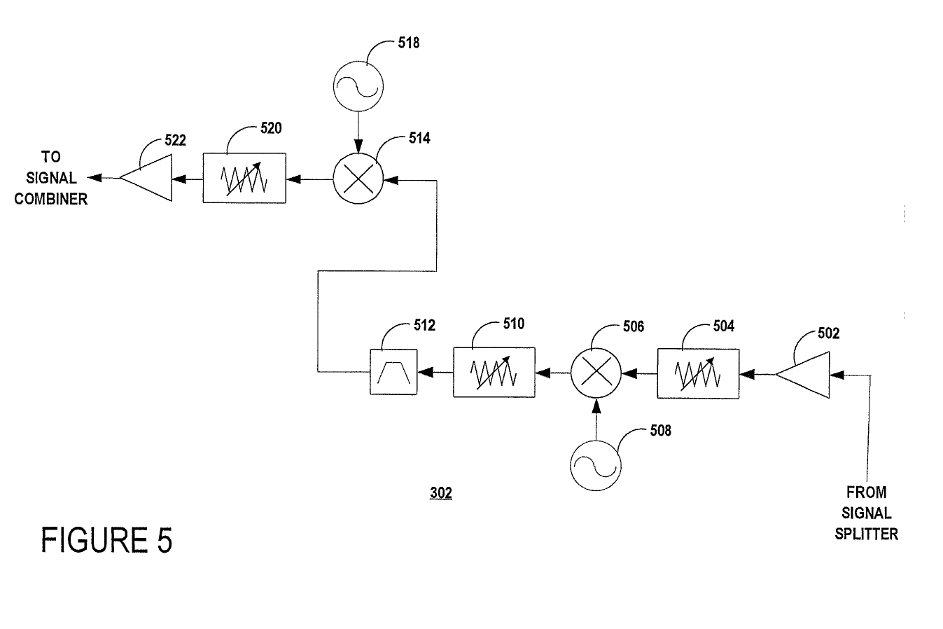

A controller 306 provides control signals to the frequency shifters 302, 304 as described below in reference to FIG. 5. In the exemplary embodiment, the controller 306 is a PC104 a microprocessor model number available from the JUMPtec® Industrielle Computertechnik AG company. The controller 306, however, may be any type of micro-processor, computer processor, processor arrangement or processor combination suitable for implementing the functionality discussed herein. Software running on the controller 306 provides the various control functions and facilitates the overall functionality of the base interface station 112.

A downstream link signal transmitted from the base station 102 at the downstream link frequency 208 is received through an power attenuator 308. In the exemplary embodiment, the power attenuator 308 is a impedance network suitable for providing an adequate load to the cellular base station 114 while absorbing the RF power transmitted by the cellular base station 114. In situations where the cellular base station 114 is not co-located with the base interface station 112, the power attenuator 308 may be an antenna.

In accordance with known techniques, a coverage duplexer 310 allows for the use of one power attenuator 308 for receiving downstream coverage signals and transmitting upstream coverage signals from and to the cellular base station 114. A Low Noise Amplifier (LNA) 312 amplifies the downstream coverage signal received through the power attenuator 308 and the coverage duplexer 310. Although several types of LNAs can be used to provide the appropriate gain and noise characteristics, an example of a suitable LNA is the LP1500-SOT89, a PHEMT (Pseudomorphic High Electron Mobility Transistor) from Filtronic Solid-State, a division of Filtronic plc.

The amplified downstream coverage signal is received at the input of a signal splitter 314. In the exemplary embodiment, the signal splitter 314 has two outputs where the signals produced at each output have a power level that is approximately 3 dB lower than the power of the signal at the input. Although the signal splitter 314 may have any number of outputs, a suitable implementation includes a number of outputs in accordance with the number of downstream coverage signals that the base interface station 112 can receive. The signal produced at each output of the signal splitter 314 is received at a downstream frequency shifter 302.

Each downstream frequency shifter 302 in the base interface station 112 shifts signals at a particular frequency of the downstream coverage channel 110 to a downstream link frequency 208 associated with the particular downstream coverage frequency. The downstream link signal has a downstream link frequency 208 within the upstream frequency bandwidth 204 allocated for upstream communication with mobile stations 106. The various frequencies of the channels can be changed by the controller 306. In the exemplary embodiment, the frequencies are configured at the time of system installation in accordance with the system frequency allocation scheme. The base interface station 112 can be configured, depending on the particular communication system 100, to dynamically adjust frequencies during operation of the building interface station 112 within the system 100.

The downstream link signals at the output of each downstream frequency shifter 302 are combined in a signal combiner 316 and amplified by an amplifier 318. A link duplexer 320 allows for downstream link signals and upstream link signals to be transmitted and received through the same link antenna 322. Although the link antenna 322 is a vertically polarized dipole antenna in the exemplary embodiment, any suitable antenna can be used.

An LNA 324 amplifies the upstream link signals that are received through the link antenna 322 and the link duplexer 320. As explained above, the upstream link signal has an upstream link frequency 206 within a downstream frequency bandwidth 202 allocated for downstream communication with mobile stations 106. The amplified upstream link signal is received at an input of a signal splitter 326. In the exemplary embodiment, the signal splitter 326 has one output for each of the coverage channels and, therefore, has two outputs. The signal produced at each output of the signal splitter 326 is received at the input of each upstream frequency shifter 304.

Each upstream frequency shifter 304 shifts the upstream link signal from the upstream link frequency 206 to the upstream coverage frequency within the downstream frequency bandwidth 202. Each resulting upstream coverage signal is amplified in an amplifier 328, 330 and combined with the other resulting upstream signals from the other upstream frequency shifter 304 in the signal combiner 332. The combined signal, which includes upstream coverage signals at two different upstream coverage frequencies is transmitted through the coverage duplexer 310 and the coverage attenuator 308 to the cellular base station 114.

The various functions of the blocks in FIG. 3 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques.

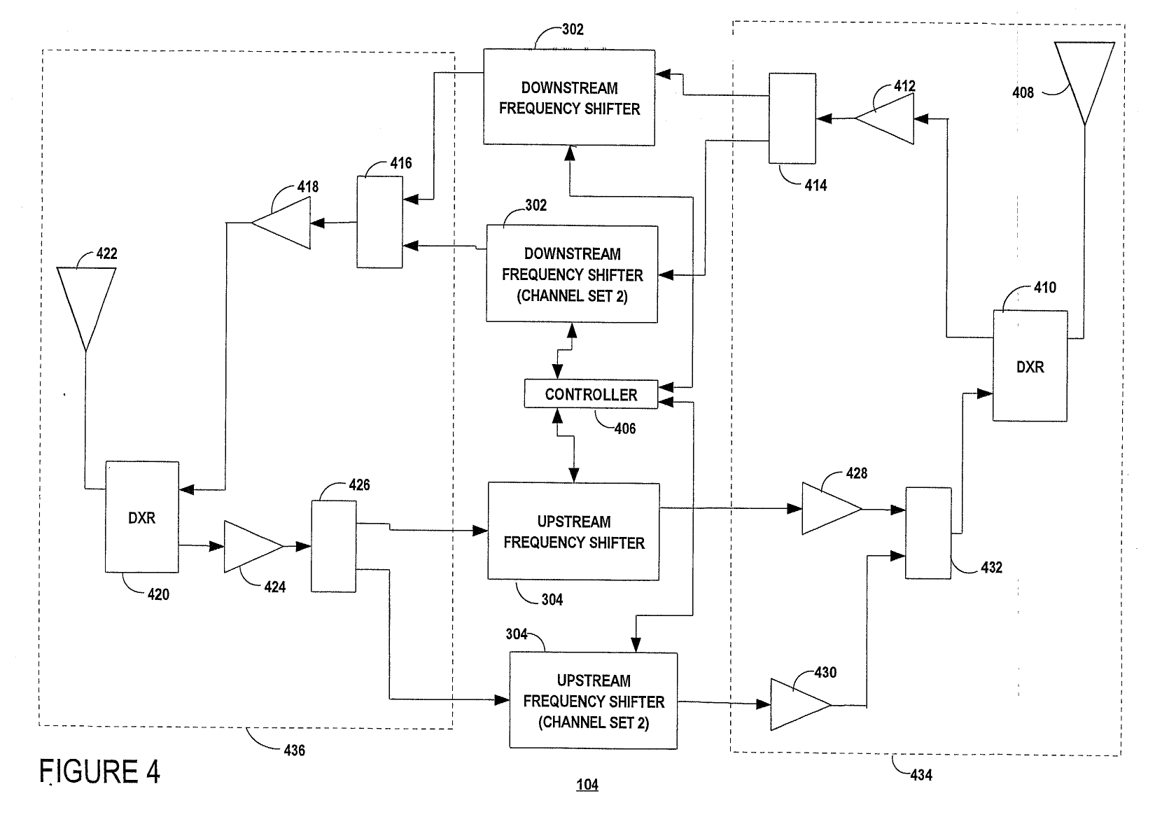

FIG. 4 is a block diagram of a distribution station 104 in accordance with the exemplary embodiment of the invention. The functional blocks in FIG. 4 may be implemented using any combination of hardware, software or firmware. The distribution station 104 in the exemplary embodiment is configured to receive two downstream distribution signals at two different frequencies and to transmit corresponding downstream coverage signals at two coverage frequencies. FIG. 4 illustrates blocks for receiving signals on two channels. The teachings herein can be expanded to implement a distribution station 104 capable of processing any number of channels. For example, in systems (100) where capacity and bandwidth are not threatened, a single downstream link channel and a single coverage channel can be used.

The distribution station 104 includes at least a link communication interface 434 for communicating through the wireless link channel 108 and a coverage communication interface 436 for communicating through the wireless coverage channel 110. The functions of the communication interfaces 434, 436 can be implemented using any combination of software, hardware and firmware. Exemplary implementations are discussed below. The blocks representing the communication interfaces 434, 436 are shown using dashed lines to indicate that each of the communication interfaces (434, 436) may include other functional blocks or portions of function blocks shown in FIG. 4. For example, either or both of the communication interfaces 434, 436 may include portions of the frequency shifters 302, 304, or the controller 406.

The distribution station 104 includes a downstream frequency shifter 302 for each channel to frequency shift an incoming downstream link signal from the downstream link frequency 208 within the upstream frequency bandwidth 204 to the downstream coverage frequency within the downstream frequency bandwidth 202. An upstream frequency shifter 304 for each coverage channel frequency shifts the upstream coverage signal from the upstream coverage frequency within the upstream frequency bandwidth 204 to the upstream link frequency 206 within the downstream frequency bandwidth 202 to form the upstream link signal.

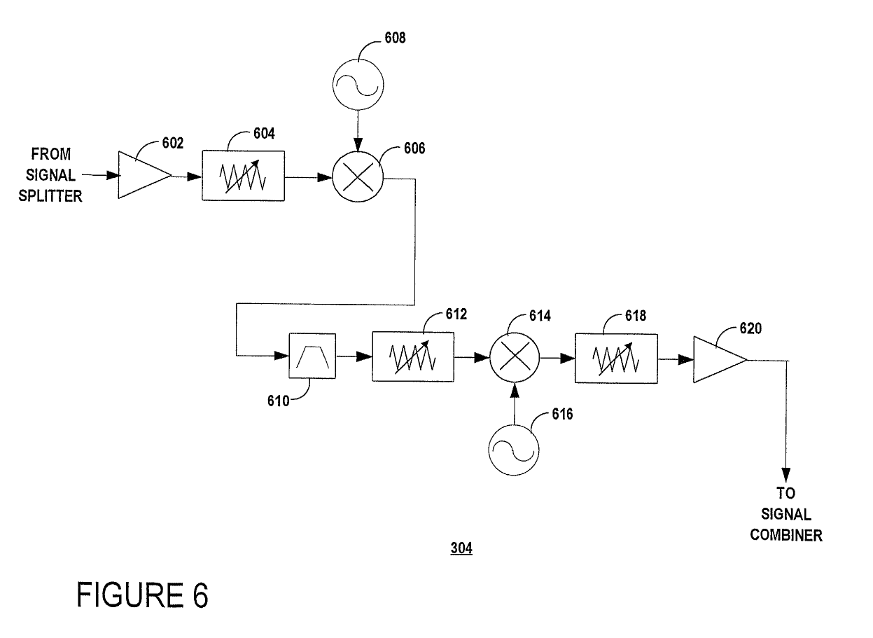

A controller 406 provides control signals to the frequency shifters 302, 404 as described below in reference to FIG. 5 and FIG. 6. In the exemplary embodiment, the controller 406 is a PC104 microprocessor available from JUMPtec® Industrielle Computertechnik AG. The controller 406, however, may be any type of micro-processor, computer processor, processor arrangement or processor combination suitable for implementing the functionality discussed herein. Software running on the controller 406 provides the various control functions and facilitates the overall functionality of the distribution station 104.

downstream link signal transmitted from the interface station 112 at the downstream link signal is received through the link antenna 408. In the exemplary embodiment, the link antenna 408 is a directional antenna aligned to maximize the signal-to-noise ratio of signals transmitted between the interface station 112 and the distribution station 104. Other types of antennas may be used and, in certain instances recognized by those skilled in the art, other types of antennas may be preferred.

In accordance with known techniques, a duplexer 410 allows for the use of a single link antenna 408 for receiving downstream link signals and transmitting upstream link signals. A Low Noise Amplifier (LNA) 412 amplifies the downstream link signal received through the link antenna 408 and the duplexer 410. Although several types of LNAs 412 can be used to provide the appropriate gain and noise characteristics, an example of a suitable LNA 412 is the LP1500-SOT89 PHEMT (Pseudomorphic High Electron Mobility Transistor) from Filtronic Solid-State, a division of Filtronic plc.

The amplified downstream link signal is received at the input of a signal splitter 414. In the exemplary embodiment, the signal splitter 414 has two outputs where the signals produced at each output have a power level that is approximately 3 dB lower than the power of the signal at the input. Although the signal splitter 414 may have any number of outputs, a suitable implementation includes a number of outputs in accordance with the number of channels that the distribution station 104 can receive. The signal at each output is received at a downstream frequency shifter 302.

As discussed in further detail below with reference to FIG. 5, the downstream frequency shifter 302 shifts the signal received at its input to a downstream coverage frequency. Each downstream frequency shifter 302 in the distribution station 104 shifts signals at the particular frequency of the wireless link channel 108 to a downstream coverage frequency associated with the particular link frequency. In the exemplary embodiment, therefore, the two downstream frequency shifters 302 shift signals at two downstream link frequencies within upstream frequency bandwidth 204 to two downstream coverage frequencies within the wireless coverage channel 136 and the downstream frequency bandwidth 202. Although the various frequencies of the channels can be changed by the controller 406, the frequencies are configured at the time of system 100 installation in accordance with the system frequency allocation scheme in the exemplary embodiment. A suitable control technique includes the use of a wireless modem system (not shown) connected to the controller 406 for channel and frequency management. The distribution station 104 can be configured, depending on the particular communication system 100, to dynamically adjust frequencies during operation of the distribution station 104 within the system 100.

The downstream coverage signals at the output of each downstream frequency shifter 302 are combined in a signal combiner 416 and amplified by an amplifier 418. A coverage duplexer 420 allows for downstream coverage signals and upstream coverage signals to be transmitted and received through the same coverage antenna 422. The coverage antenna 422 is a vertically polarized directional antenna, such as the S1857AMP10SMF antenna from Cushcraft Communications. The coverage antenna 422, however, may have any one of several configurations or polarization depending on the particular communication system 100.

An LNA 424 amplifies the upstream coverage signals that are received through the coverage antenna 422 and the coverage duplexer 420. The amplified upstream coverage signal is received at an input of a signal splitter 426. In the exemplary embodiment, the signal splitter 426 has one output for each of the coverage channels and, therefore, has two outputs. The signals produced at each output of the signal splitter 426 are received at the input of each upstream frequency shifter 304. The upstream frequency shifter 304 shifts the upstream coverage signal from the upstream coverage frequency to the upstream distribution frequency.

As discussed in further detail below with reference to FIG. 6, the upstream frequency shifter 304 shifts the signal received at its input to the upstream link frequency 206. Each upstream frequency shifter 304 in the distribution station 104 shifts signals at the particular upstream coverage frequency of the wireless coverage channel 110 to an upstream link frequency 206 associated with the particular coverage frequency and within the downstream frequency bandwidth 202. In the exemplary embodiment, therefore, the two upstream frequency shifters 304 shift two signals at two upstream coverage frequencies to two upstream link frequencies. The upstream coverage signals at the output of each upstream frequency shifter 304 are amplified by amplifiers 428, 430 and combined in a signal combiner 432 before transmission to the interface station 112 through the duplexer 432 and the link antenna 408.

FIG. 5 is a block diagram of a downstream frequency shifter 302 in accordance with exemplary embodiment of the invention suitable for use within the interface station 112 and the distribution station 104. The downstream signal is received at an input of an amplifier 502 and amplified. A variable attenuator 504 is adjusted to provide the appropriate power level of the downstream signal to a signal mixer 506. Those skilled in the art will recognize the various techniques and devices that can be used to adjust the signal power level into the downstream signal mixer 506.

The downstream signal mixer 506 mixes the downstream signal with a mixing signal generated by an oscillator 508 to shift the downstream signal to an intermediate frequency (IF). The signal mixer 506 is a down-mixer and the IF is approximately 199 MHz in the exemplary embodiment. The IF, however, can be any suitable frequency chosen in accordance with known techniques and will depend on the particular communication system 100 requirements.

The power level is adjusted by another attenuator 510 prior to filtering in a band-pass filter 512. The band-pass filter 512 is a Surface Acoustic Wave (SAW) filter having a bandwidth of approximately 0.2 MHz. Any one of several filters can be used where the selection depends on the type of system 100, bandwidth of the transmitted signal, the required Signal-to-Noise (SNR) ratio of the signals, the isolation required between coverage and distribution frequencies, and several other factors recognized by those skilled in the art. The band-pass filter 512 attenuates signals outside the desired frequency bandwidth and allows the desired signals to pass to the signal mixer 514.

In the exemplary embodiment, the oscillator 508 is controlled by the controller (306, 406) and the frequency of the mixing signal can be changed to select the desired channel to be received. A suitable configuration of the mixer 506 and oscillator 508 includes using a voltage controlled oscillator (VCO) and setting the frequency of the mixing signal through a control signal produced by the controller (306, 406).

In the distribution station 104, the filtered IF signal produced at the output of the band-pass filter 512 is mixed with a mixing signal produced by the oscillator 518 in the signal mixer 514 to shift the downstream signal to the downstream coverage frequency. The downstream signal is frequency shifted to the downstream link frequency 208, in the interface station 112, by mixing the IF signal with the appropriate mixing signal generated by the oscillator 518. The controller (306, 406) provides control signals to the oscillators 508, 518 to adjust the frequencies of the mixing signals to select the received and transmitted downstream frequencies.

The power level of the downstream signal is adjusted in the attenuator 520 and amplified in the amplifier 522. The level of the signals, however, may be adjusted using any one of several known techniques.

FIG. 6 is a block diagram of an upstream frequency shifter suitable for use in the distribution station 104 and the interface station 112. The upstream signal received at an amplifier 602 is amplified. A variable attenuator 604 is adjusted to provide the appropriate power level of the upstream signal to an upstream link mixer 606. In the exemplary embodiment, analog power control signals generated by the controller (306, 406) are received at a control inputs of the variable attenuators in the upstream frequency shifter 304. Other techniques can be used to provide an upstream signal with the appropriate power level to the upstream signal mixer 606.

An oscillator 608 provides a mixing signal to the upstream signal mixer 506 to shift the signal to an IF. The frequency of the mixing signal can be changed by the controller (306, 406) by adjusting a control signal presented to a control input of the oscillator 608. The frequency of the received upstream signal, therefore, is determined by a control signal generated by the controller 306, 406.

The upstream IF signal is filtered by a band-pass filter 610 before being received at a variable attenuator 612. The band-pass filter 610 is a Surface Acoustic Wave (SAW) filter having a bandwidth of bandwidth of approximately 0.2 MHz. Any one of several filters, however, can be used where the choice depends on the particular type of communication system 100, bandwidth of the transmitted signal, the required Signal-to-Noise (SNR) ratio of the signals, the isolation required between coverage and link signals. The band-pass filter 610 attenuates signals outside the desired frequency bandwidth and allows the desired signals to pass to the variable attenuator 612 and the upstream signal mixer 614.

In the distribution station 104, an oscillator 616 provides a mixing signal to the upstream signal mixer 614 to shift the upstream IF filtered signal to the upstream link frequency 206 within the downstream frequency bandwidth 202. In the base interface station 128, the IF signal is mixed with the mixing signal from the oscillator 616 to shift the upstream link signal within the downstream frequency bandwidth 202 to the upstream coverage frequency within the upstream frequency bandwidth 204. The frequency of the mixing signal can be changed by the controller (306, 406) by adjusting a control signal presented to a control input of the oscillators 608, 616. The frequencies of the transmitted upstream link signal and the upstream coverage signal, therefore, are determined by control signals generated by the controller 306, 406 in the exemplary embodiment. The power level of the upstream signal is adjusted by a variable attenuator 618 and amplified by an amplifier 620.

The various functions of the blocks in FIG. 5 and FIG. 6 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques. Further, the upstream frequency shifter and the downstream frequency shifter may implemented as single integrated circuit such as an Application Specific Integrated Circuit (ASIC), using discrete components or any combination thereof.

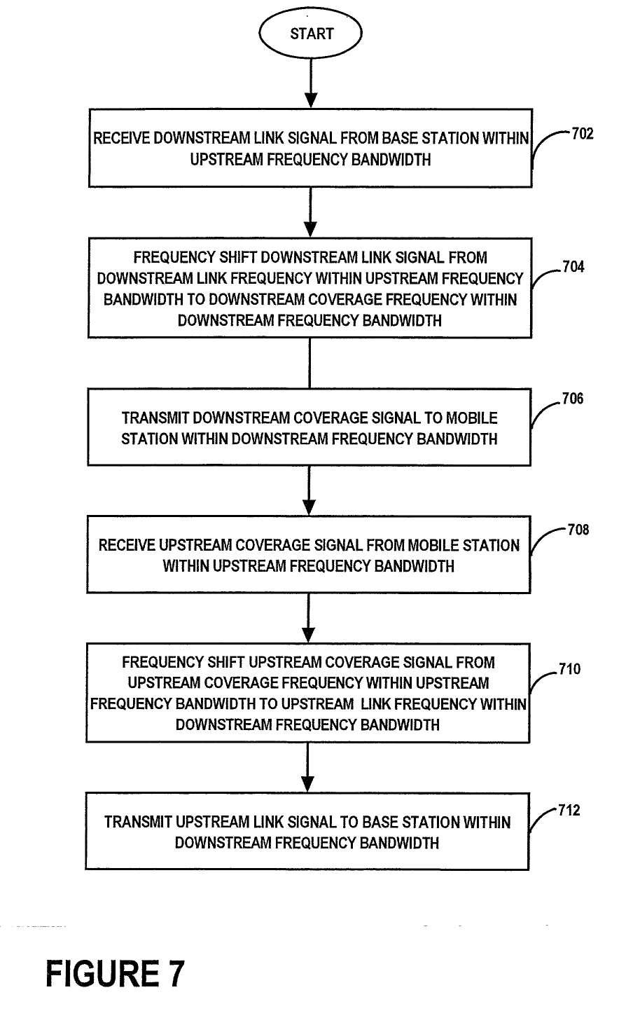

FIG. 7 is a flow chart of a method of communicating between the base station and a mobile station in accordance with the exemplary embodiment of the invention. Although the method is performed in a distribution station 104 in the exemplary embodiment, the method can wholly or partially be performed by other components of the system 100. Software code running on the processor or controller 406 within the distribution station 104 directs the execution of the steps of the method in addition to facilitating the overall functionality of the distribution station 104, and other functions. The method, however, may be performed using any combination of software, hardware, or firmware.

At step 702, the distribution station 104 receives a downstream link signal, within the upstream frequency bandwidth 204, from the base station 102. A explained above, the upstream frequency bandwidth 204 is allocated to the cellular communication system for communication with mobile stations 106 in the upstream direction. Components within the link interface form a receiver that receives the downstream link signal. In the exemplary embodiment, the oscillators, mixers, and other components within the distribution station 104 are used to frequency shift the downstream link signal to an IF and receive the downstream link signal.

At step 704, the downstream link signal is frequency shifted from the downstream link frequency 208 within the upstream frequency bandwidth 204 to the downstream coverage frequency within the downstream frequency bandwidth 202. In the exemplary embodiment, the downstream link signal is shifted to the IF, as explained in step 702, and shifted from the IF to the downstream coverage frequency using oscillators, mixers and other components under the control of the controller within the distribution station 104.

At step 706, the distribution station 104 transmits the downstream coverage signal to the mobile station 106. The coverage interface 436 transmits the downstream coverage signal at the downstream coverage frequency within the downstream frequency bandwidth 202 through the wireless coverage channel 110. Components within the coverage interface 436 form a transmitter that transmits the downstream coverage signal.

At step 708, the distribution station 104 receives an upstream coverage signal, within the upstream frequency bandwidth 204, from the mobile station 106. The coverage interface 436 receives the upstream coverage signal at the upstream coverage frequency. In the exemplary embodiment, oscillators, mixers, filters and other components shift the upstream coverage signal to an IF to receive the signal.

At step 710, the upstream coverage signal is frequency shifted from the upstream coverage frequency within the upstream frequency bandwidth 204 to the upstream link frequency 206 within the downstream frequency bandwidth 202. In the exemplary embodiment, the upstream coverage signal is shifted to the IF, as explained in step 708, and shifted from the IF to the upstream link frequency 206 using oscillators, mixers and other components within the distribution station 104.

At step 712, the upstream link signal is transmitted within the downstream frequency bandwidth 202 to the base station. The link communication interface 434 transmits the upstream link signal at the upstream link frequency 206 within the downstream frequency bandwidth 202 through the wireless link channel 108. Components within the link interface form a transmitter that transmits the upstream link signal to the base station.

Therefore, the distribution station 104 communicates, in a first communication direction, with a base station using a link frequency within a first frequency bandwidth allocated for communication with a mobile station in a second communication direction. The distribution station also communicates with the mobile station in the second direction with signal corresponding to the signal exchanged through with the base station. At steps 702- 706, the first communication direction is downstream and the second communication direction is upstream and, at steps 708-12, the first communication direction is upstream and the second communication direction is downstream.

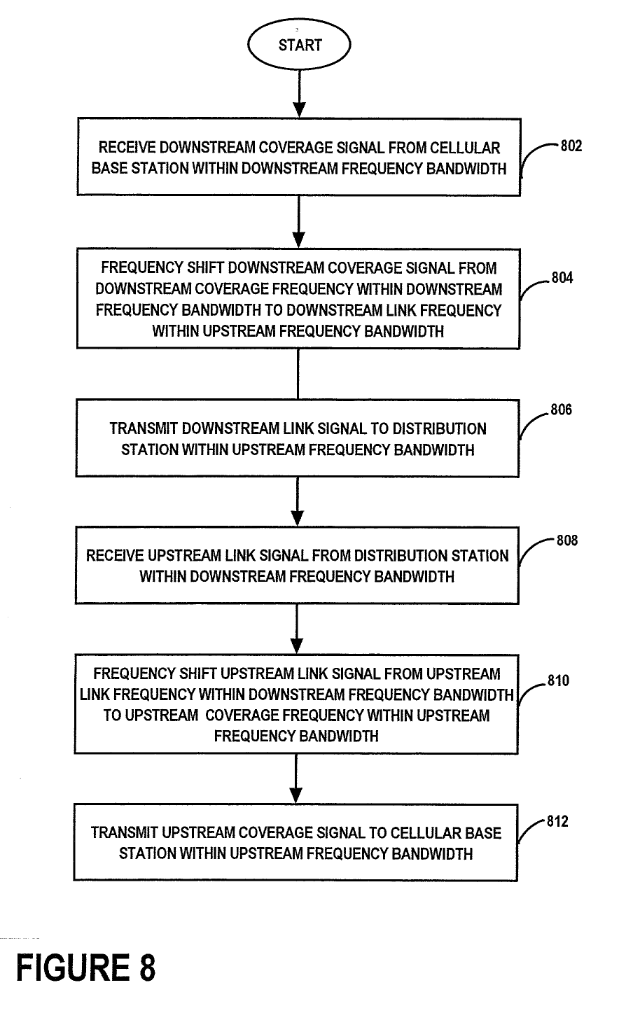

FIG. 8 is flow chart of a method of communicating between a cellular base station and a distribution station in accordance with the exemplary embodiment of the invention. Although the method is performed in the interface station 112 in the exemplary embodiment, the method can wholly or partially be performed by other components of the system 100. Software code running on the processor or controller 306 within the interface station 112 directs the execution of the steps of the method in addition to facilitating the overall functionality of the interface station 112, and other functions. The method, however, may be performed using any combination of software, hardware, or firmware.

At step 802, the interface station 112 receives a downstream coverage signal, within the downstream frequency bandwidth 202, from the cellular base station 114. In the exemplary embodiment, communication signals are exchanged between the cellular base station and the interface station through a coaxial cable. Components within the base interface form a receiver that receives the downstream coverage signal. In the exemplary embodiment, the oscillators, mixers, and other components within the interface station 112 are used to frequency shift the downstream coverage signal to an IF and receive the downstream coverage signal.

At step 804, the downstream coverage signal is frequency shifted from the downstream coverage frequency within the downstream frequency bandwidth 202 to the downstream link frequency 208 within the upstream frequency bandwidth 204. In the exemplary embodiment, the downstream coverage signal is shifted to the IF, as explained in step 802, and shifted from the IF to the downstream link frequency 208 using oscillators, mixers and other components under the control of the controller within the interface station 112.

At step 806, the interface station 112 transmits the downstream link signal to the distribution station 104. The link interface 336 transmits the downstream link signal at the downstream link frequency 208 within the upstream frequency bandwidth 204 through the wireless link channel 108. Components within the link interface form a transmitter that transmits the downstream link signal.

At step 808, the interface station 112 receives an upstream link signal, within the downstream frequency bandwidth 202, from the distribution station 104. The link interface receives the upstream link signal at the upstream coverage frequency. In the exemplary embodiment, oscillators, mixers, filters and other components shift the upstream link signal to an IF to receive the signal.

At step 810, the upstream link signal is frequency shifted from the upstream link frequency 206 within the downstream frequency bandwidth 202 to the upstream coverage frequency within the upstream frequency bandwidth 204. In the exemplary embodiment, the upstream link signal is shifted to the IF, as explained in step 708, and shifted from the IF to the upstream coverage frequency using oscillators, mixers and other components within the interface station 112.

At step 812, the upstream coverage signal is transmitted within the upstream frequency bandwidth 204 to the cellular base station. The base interface 334 transmits the upstream coverage signal at the upstream coverage frequency within the upstream frequency bandwidth 204. Components within the base interface form a transmitter that transmits the upstream coverage signal to the cellular base station through the coaxial cable.

In the exemplary embodiment, therefore, link signals forming a wireless backhaul in a communication system are transmitted at frequencies within frequency bandwidths allocated for the communication in the opposite direction. Downstream link signals are transmitted within the upstream frequency bandwidth, while upstream link signals are transmitted within the downstream frequency bandwidth. Mobile stations 106 can receive signals at frequencies within the downstream frequency bandwidth and transmit signals at frequencies within upstream frequency bandwidth. Accordingly, the mobile stations 106 can not communicate directly with the interface station 112 or the base station 102 on the link channels.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

I CLAIM:

1. A method comprising:
communicating, in a first communication direction, with a base station using a link frequency within a first frequency bandwidth allocated for communication with a mobile station in a second communication direction.

2. A method in accordance with claim 1, further comprising:
communicating, in the first communication direction, with the mobile station using a coverage signal within a second frequency bandwidth allocated for communication with a mobile station in first communication direction.

3. A method in accordance with claim 2, wherein the communicating in the first communication direction with the base station comprises:
exchanging a link signal corresponding to a coverage signal exchanged with the mobile station.

4. A method in accordance with claim 3, further comprising:
communicating, in the second communication direction, with the base station using a second link frequency within the second frequency bandwidth allocated for communication with a mobile station in the first communication direction.

5. A method in accordance with claim 4, wherein the communicating, in the second communication direction, with the base station comprises:
exchanging a second link signal corresponding to a second coverage signal exchanged with the mobile station in the second communication direction.

6. A method in accordance with claim 5, wherein:
the first communication direction is upstream,
the second communication direction is downstream,
the link frequency is an upstream link frequency;
the first frequency bandwidth is a downstream frequency bandwidth allocated for downstream communication with the mobile station, and
the second frequency bandwidth is an upstream frequency bandwidth allocated for upstream communication with the mobile station.

7. A method in accordance with claim 6, wherein the communicating in a first communication direction comprises:
transmitting an upstream link signal at the upstream link frequency to the base station, the upstream link signal corresponding to an upstream coverage signal received from the mobile station within the upstream frequency bandwidth.

8. A method in accordance with claim 7, wherein the communicating in the first communication direction with the mobile station comprises:
receiving the upstream coverage signal from the mobile station.

9. A method in accordance with claim 8, wherein the communicating in the second communication direction with the base station comprises:
receiving a downstream link signal at a downstream link frequency within the upstream frequency bandwidth, the downstream link signal corresponding to a downstream coverage signal transmitted to the mobile station within the downstream frequency bandwidth.

10. A method in accordance with claim 5, wherein:
the first communication direction is downstream,
the second communication direction is upstream,
the link frequency is a downstream link frequency;
the first frequency bandwidth is an upstream frequency bandwidth allocated for upstream communication with the mobile station, and
the second frequency bandwidth is a downstream frequency bandwidth allocated for downstream communication with the mobile station.

11. A method in accordance with claim 10, wherein the communicating in a first communication direction comprises:
receiving a downstream link signal at the downstream link frequency from the base station, the downstream link signal corresponding to a downstream coverage signal transmitted to the mobile station within the downstream frequency bandwidth.

12. A method in accordance with claim 11, wherein the communicating in the first communication direction with the mobile station comprises:
transmitting the downstream coverage signal to the mobile station.

13. A method in accordance with claim 12, wherein the communicating in the second communication direction with the base station comprises:
transmitting an upstream link signal at an upstream link frequency within the downstream frequency bandwidth, the upstream link signal corresponding to an upstream coverage signal received from the mobile station within the upstream frequency bandwidth.

14. A method comprising:
receiving, from a mobile station, an upstream coverage signal at an upstream coverage frequency within an upstream frequency bandwidth allocated for upstream communication with the mobile station; and
transmitting, to a base station, an upstream link signal at an upstream link frequency within a downstream frequency bandwidth allocated for downstream communication with the mobile station, the upstream link signal corresponding to the upstream coverage signal.

15. A method in accordance with claim 14, further comprising:
frequency shifting the upstream coverage signal to the upstream link frequency to form the upstream link signal.

16. A method in accordance with claim 15, further comprising:
receiving, from the base station, a downstream link signal at a downstream link frequency within the upstream frequency bandwidth; and
transmitting, to the mobile station, a downstream coverage signal at a downstream coverage frequency within the downstream frequency bandwidth.

17. A method in accordance with claim 16, further comprising:
frequency shifting the downstream link signal to the downstream coverage frequency to form the downstream coverage signal.

18. A method in accordance with claim 17, wherein the downstream coverage frequency and the upstream coverage frequency form one frequency pair of a plurality of frequency pairs, each frequency pair having an upstream frequency and a downstream frequency separated by the frequency difference.

19. A method comprising:
receiving, from a interface station communicatively connected to a cellular base station, a downstream link signal at a downstream link frequency within an upstream frequency bandwidth allocated to the cellular base station for upstream communication with a mobile station, the downstream link signal corresponding to a downstream coverage signal transmitted from the cellular base station to the interface station,
frequency shifting the downstream link signal to a downstream coverage frequency to form the downstream coverage signal;
transmitting the downstream coverage signal to the mobile station;
receiving, from the mobile station, an upstream coverage signal at an upstream coverage frequency within the upstream frequency bandwidth;
frequency shifting the upstream coverage signal to an upstream link frequency within a downstream frequency bandwidth allocated to the cellular base station for downstream communication with the mobile station to form an upstream link signal; and
transmitting the upstream link signal to the interface station, the upstream link signal corresponding to an upstream coverage signal transmitted from interface station to the cellular base station.

20. A method in accordance with claim 19, wherein the downstream coverage frequency and the upstream coverage frequency are separated by a frequency difference and form one frequency pair of a plurality of frequency pairs, each frequency pair having an upstream frequency and a downstream frequency separated by the frequency difference.

21. A method in accordance with claim 20, wherein the upstream frequency bandwidth comprises a plurality of upstream coverage channels at upstream coverage frequencies and at least one downstream link channel.

22. A method in accordance with claim 20, wherein the downstream frequency bandwidth comprises a plurality of downstream coverage channels at the downstream coverage frequencies and at least one upstream link channel.

23. A method comprising:
communicating, in a first communication direction, with a distribution station using a link frequency within a first frequency bandwidth allocated for communication with a mobile station in a second communication direction.

24. A method in accordance with claim 23, further comprising:
communicating, in the first communication direction, with a cellular base station using a coverage signal within a second frequency bandwidth allocated for communication with the mobile station in first communication direction.

25. A method in accordance with claim 24, wherein the communicating in the first communication direction with the distribution station comprises:
exchanging a link signal corresponding to a coverage signal exchanged with the cellular base station.

26. A method in accordance with claim 25, further comprising:
communicating, in the second communication direction, with the distribution station using a second link frequency within the second frequency bandwidth allocated for communication with the mobile station in the first communication direction.

27. A method in accordance with claim 26, wherein the communicating, in the second communication direction, with the distribution station comprises:
exchanging a second link signal corresponding to a second coverage signal exchanged with the cellular base station in the second communication direction.

28. A method in accordance with claim 27, wherein:
the first communication direction is upstream, the second communication direction is downstream,
the link frequency is an upstream link frequency;
the first frequency bandwidth is a downstream frequency bandwidth allocated for downstream communication with the mobile station, and
the second frequency bandwidth is an upstream frequency bandwidth allocated for upstream communication with the mobile station.

29. A method in accordance with claim 28, wherein the communicating in a first communication direction comprises:
receiving an upstream link signal at the upstream link frequency from the distribution station, the upstream link signal corresponding to an upstream coverage signal transmitted to the cellular base station within the upstream frequency bandwidth.

30. A method in accordance with claim 29, wherein the communicating in the first communication direction with the cellular base station comprises:
transmitting the upstream coverage signal to the cellular base station.

31. A method in accordance with claim 30, wherein the communicating in the second communication direction with the distribution station comprises:
transmitting a downstream link signal at a downstream link frequency within the upstream frequency bandwidth, the downstream link signal corresponding to a downstream coverage signal received from the cellular base station within the downstream frequency bandwidth.

32. A method in accordance with claim 27, wherein:
the first communication direction is downstream,
the second communication direction is upstream,
the link frequency is downstream link frequency;
the first frequency bandwidth is an upstream frequency bandwidth allocated for upstream communication with the mobile station, and
the second frequency bandwidth is a downstream frequency bandwidth allocated for downstream communication with the mobile station.

33. A method in accordance with claim 32, wherein the communicating in a first communication direction comprises:
transmitting a downstream link signal at the downstream link frequency to the distribution station, the downstream link signal corresponding to a downstream coverage signal received from the cellular base station within the downstream frequency bandwidth.

34. A method in accordance with claim 33, wherein the communicating in the first communication direction with the cellular base station comprises:
receiving the downstream coverage signal from the cellular base station.

35. A method in accordance with claim 34, wherein the communicating in the second communication direction with the distribution station comprises:
receiving an upstream link signal at an upstream link frequency within the downstream frequency bandwidth, the upstream link signal corresponding to an upstream coverage signal transmitted to cellular base station within the upstream frequency bandwidth.

36. A method in accordance with claim 23, wherein the distribution station is configured to exchange a mobile coverage signal with the mobile station corresponding to a cellular base station coverage signal exchanged with the cellular base station.

37. A method comprising:
receiving, from a cellular base station, a downstream coverage signal at a downstream coverage frequency within a downstream frequency bandwidth allocated for downstream communication with the mobile station; and
transmitting, to a distribution station, a downstream link signal at an downstream link frequency within an upstream frequency bandwidth allocated for upstream communication with the mobile station, the downstream link signal corresponding to the downstream coverage signal.

38. A method in accordance with claim 37, further comprising:
frequency shifting the downstream coverage signal to the downstream link frequency to form the downstream link signal.

39. A method in accordance with claim 38, further comprising:
receiving, from the distribution station, an upstream link signal at an upstream link frequency within the downstream frequency bandwidth; and
transmitting, to the cellular base station, an upstream coverage signal at an upstream coverage frequency within the upstream frequency bandwidth.

40. A method in accordance with claim 39, further comprising:
frequency shifting the upstream link signal to the upstream coverage frequency to form the upstream coverage signal.

41. A method in accordance with claim 40, wherein the downstream coverage frequency and the upstream coverage frequency form one frequency pair of a plurality of frequency pairs, each frequency pair having an upstream frequency and a downstream frequency separated by the frequency difference.

42. A method comprising:
receiving, from a distribution station in wireless communication with a mobile station, an upstream link signal at a upstream link frequency within a downstream frequency bandwidth allocated to the cellular base station for downstream communication with the mobile station, the upstream link signal corresponding to an upstream coverage signal transmitted from the mobile station to the distribution station,
frequency shifting the upstream link signal to an upstream coverage frequency to form the upstream coverage signal;
transmitting the upstream coverage signal to the cellular base station;
receiving, from the cellular base station, a downstream coverage signal at an downstream coverage frequency within the downstream frequency bandwidth;
frequency shifting the downstream coverage signal to a downstream link frequency within an upstream frequency bandwidth allocated to the cellular base station for upstream communication with the mobile station to form a downstream link signal; and
transmitting the downstream link signal to the distribution station, the downstream link signal corresponding to a downstream coverage signal transmitted from the distribution station to the mobile station.

43. A method in accordance with claim 42, wherein the downstream coverage frequency and the upstream coverage frequency are separated by a frequency difference and form one frequency pair of a plurality of frequency pairs, each frequency pair having an upstream frequency and a downstream frequency separated by the frequency difference.

44. A method in accordance with claim 43, wherein the upstream frequency bandwidth comprises a plurality of upstream coverage channels at upstream coverage frequencies and at least one downstream link channel.

45. A method in accordance with claim 43, wherein the downstream frequency bandwidth comprises a plurality of downstream coverage channels at the downstream coverage frequencies and at least one upstream link channel.

46. A method comprising:
exchanging a link signal, in a first communication direction, between a base station and a distribution station using a link frequency within a first frequency bandwidth allocated for communication between the mobile station and the base station in a second communication direction; and
exchanging a coverage signal corresponding to the link signal, in the first communication direction, between the mobile station and the distribution station using a coverage frequency within a second frequency bandwidth allocated for communication between the mobile station and the base station in the first communication direction.

47. A method in accordance with claim 46, further comprising:
exchanging, in the second communication direction, another link signal between the base station and the distribution station using another link frequency within the second frequency bandwidth allocated for communication between the mobile station and the base station in the first communication direction; and
exchanging, in the second communication direction, another coverage signal corresponding to the another link signal between the mobile station and the distribution station.

48. A method in accordance with claim 47, wherein:
the first communication direction is upstream,
the second communication direction is downstream,
the link frequency is an upstream link frequency;
the first frequency bandwidth is a downstream frequency bandwidth allocated for downstream communication between base station and the mobile station, and
the second frequency bandwidth is an upstream frequency bandwidth allocated for upstream communication between the mobile station and the base station.

49. A method in accordance with claim 48, wherein the exchanging the link signal in a first communication direction comprises:
transmitting an upstream link signal at the upstream link frequency from the distribution station to the base station, the upstream link signal corresponding to an upstream coverage signal received from the mobile station within the upstream frequency bandwidth.

50. A method in accordance with claim 49, wherein the exchanging the coverage signal in the first communication direction comprises:
receiving the upstream coverage signal from the mobile station.

51. A method in accordance with claim 50, wherein the communicating in the second communication direction between the base station and the distribution station comprises:
transmitting a downstream link signal at a downstream link frequency within the upstream frequency bandwidth from the base station to the distribution station, the downstream link signal corresponding to a downstream coverage signal transmitted to the mobile station within the downstream frequency bandwidth.

52. A method in accordance with claim 48, wherein:
the first communication direction is downstream,
the second communication direction is upstream,
the link frequency is downstream link frequency;
the first frequency bandwidth is an upstream frequency bandwidth allocated for upstream communication with the mobile station, and
the second frequency bandwidth is a downstream frequency bandwidth allocated for downstream communication with the mobile station.

53. A method in accordance with claim 52, wherein the exchanging the link signal in a first communication direction comprises:
transmitting a downstream link signal at the downstream link frequency from the base station to the distribution station, the downstream link signal corresponding to a downstream coverage signal transmitted to the mobile station within the downstream frequency bandwidth.

54. A method in accordance with claim 53, wherein the exchanging the coverage signal in the first communication direction with the mobile station comprises:
transmitting the downstream coverage signal to the mobile station.

55. A method in accordance with claim 54, wherein the exchanging the link signal in the second communication direction with the base station comprises:
transmitting an upstream link signal at an upstream link frequency within the downstream frequency bandwidth from the distribution station to the base station, the upstream link signal corresponding to an upstream coverage signal received from the mobile station within the upstream frequency bandwidth.

56. A method comprising:
receiving, from a mobile station, an upstream coverage signal at an upstream coverage frequency within an upstream frequency bandwidth allocated for upstream communication with the mobile station; and
transmitting from a distribution station to an interface base station, an upstream link signal at an upstream link frequency within a downstream frequency bandwidth allocated for downstream communication with the mobile station, the upstream link signal corresponding to the upstream coverage signal; and
transmitting from the interface station to a cellular base station, the upstream coverage signal.

57. A method in accordance with claim 56, further comprising:
frequency shifting, at the distribution station, the upstream coverage signal to the upstream link frequency to form the upstream link signal; and
frequency shifting, at the interface station, the upstream link signal from the upstream link frequency to the upstream coverage frequency to form the upstream coverage signal.

58. A method in accordance with claim 57, further comprising:
receiving, at the interface station from the base station, a downstream coverage signal at a downstream coverage frequency within the downstream frequency bandwidth,
transmitting a downstream link signal at a downstream link frequency within the upstream frequency bandwidth to the distribution station; and
transmitting, to the mobile station, the downstream coverage signal at the downstream coverage frequency within the downstream frequency bandwidth.

59. A method in accordance with claim 58, further comprising:
frequency shifting, at the interface station, the downstream coverage signal to the downstream link frequency to form the downstream link signal; and
frequency shifting, at the distribution station, the downstream link signal to the downstream coverage frequency to form the downstream coverage signal.

60. A method in accordance with claim 59, wherein the downstream coverage frequency and the upstream coverage frequency form one frequency pair of a plurality of frequency pairs, each frequency pair having an upstream frequency and a downstream frequency separated by the frequency difference.

61. A method comprising:
receiving, at an interface station communicatively connected to a cellular base station, a downstream coverage signal at a downstream coverage frequency within a downstream frequency bandwidth allocated to the cellular base station for downstream communication with a mobile station;
frequency shifting, at the interface station, the downstream coverage signal to a downstream link frequency within an upstream frequency bandwidth allocated to the cellular base station for upstream communication between a mobile station and the cellular base station,
transmitting, from the interface station to a distribution station the downstream link signal;
frequency shifting, at the distribution station, the downstream link signal to the downstream coverage frequency to form the downstream coverage signal;
transmitting the downstream coverage signal to the mobile station;
receiving at the distribution station from the mobile station, an upstream coverage signal at an upstream coverage frequency within the upstream frequency bandwidth;
frequency shifting, at the distribution station, the upstream coverage signal to an upstream link frequency within a downstream frequency bandwidth allocated to the cellular base station for downstream communication between the cellular base station and the mobile station to form an upstream link signal;
transmitting the upstream link signal from the distribution station to the interface station;
frequency shifting, at the interface station, the upstream link frequency to the upstream coverage frequency to form the upstream coverage signal; and
transmitting the upstream coverage frequency from the interface station to the cellular base station.

62. A method in accordance with claim 61, wherein the downstream coverage frequency and the upstream coverage frequency are separated by a frequency difference and form one frequency pair of a plurality of frequency pairs, each frequency pair having an upstream frequency and a downstream frequency separated by the frequency difference.

63. A method in accordance with claim 62, wherein the upstream frequency bandwidth comprises a plurality of upstream coverage channels at upstream coverage frequencies and at least one downstream link channel.

64. A method in accordance with claim 62, wherein the downstream frequency bandwidth comprises a plurality of downstream coverage channels at the downstream coverage frequencies and at least one upstream link channel.

65. An apparatus comprising:
a link communication interface configured to communicate, in a first communication direction, with a base station using a link frequency within a first frequency bandwidth allocated for communication with a mobile station in a second communication direction; and
a coverage communication interface configured to communicate with a mobile station in the first communication direction using a coverage frequency within a second frequency bandwidth allocated for communication with a mobile station in first communication direction.

66. An apparatus in accordance with claim 65, wherein:
the link communication interface is further configured to exchange a link signal at the link frequency with the base station; and
the coverage communication interface is further configured to exchange a coverage signal corresponding to the link signal, at the coverage frequency, with the mobile station.

67. An apparatus in accordance with claim 65, wherein the link communication interface is further configured to communicate, in the second communication direction, with the base station using a second link frequency within the second frequency bandwidth allocated for communication with the mobile station in the first communication direction.

68. An apparatus in accordance with claim 65, wherein:
the link communication interface is further configured to communicate, in the second communication direction, with the base station by exchanging a second link signal; and
the coverage communication interface is further configured to exchange a second coverage signal with the mobile station, the second coverage signal corresponding to the second link signal.

69. A apparatus in accordance with claim 68, wherein:
the first communication direction is upstream,
the second communication direction is downstream,
the link frequency is an upstream link frequency;
the first frequency bandwidth is a downstream frequency bandwidth allocated for downstream communication with the mobile station, and
the second frequency bandwidth is an upstream frequency bandwidth allocated for upstream communication with the mobile station.

70. An apparatus in accordance with claim 69, wherein:
the link interface comprises a transmitter configured to transmit an upstream link signal at the upstream link frequency to the base station, and
the coverage interface comprises a receiver configured to receive an upstream coverage signal from the mobile station within the upstream frequency bandwidth, the upstream link signal corresponding to the upstream coverage signal.

71. An apparatus in accordance with claim 70, further comprising:
an upstream frequency shifter configured to frequency shift the upstream coverage signal to the upstream link signal to form the upstream link signal.

72. An apparatus in accordance with claim 71, wherein:
the link interface comprises a receiver configured to receive a downstream link signal at the downstream link frequency from the base station, and
the coverage interface comprises a transmitter configured to transmit a downstream coverage signal to the mobile station within the downstream frequency bandwidth, the downstream coverage signal corresponding to the downstream link signal.

73. An apparatus in accordance with claim 72, further comprising:
a downstream frequency shifter configured to frequency shift the downstream link signal to the downstream coverage frequency to form the downstream coverage signal.

74. An apparatus in accordance with claim 68, wherein:
the first communication direction is downstream,
the second communication direction is upstream,
the link frequency is downstream link frequency;
the first frequency bandwidth is an upstream frequency bandwidth allocated for upstream communication with the mobile station, and
the second frequency bandwidth is a downstream frequency bandwidth allocated for downstream communication with the mobile station.

75. An apparatus in accordance with claim 74, wherein:
the link interface comprises a receiver configured to receive a downstream stream link signal at the downstream link frequency from the base station, and
the coverage interface comprises a transmitter configured to transmit a downstream coverage signal to the mobile station within the downstream frequency bandwidth, the downstream link signal corresponding to the downstream coverage signal.

76. An apparatus in accordance with claim 75, further comprising:
a downstream frequency shifter configured to frequency shift the downstream link signal to the downstream coverage frequency to form the downstream coverage signal.

77. An apparatus in accordance with claim 71, wherein:
the link interface further comprises a transmitter configured to transmit an upstream link signal at the upstream link frequency to the base station, and
the coverage interface comprises a receiver configured to receive an upstream coverage signal from the mobile station within the upstream frequency bandwidth, the upstream coverage signal corresponding to the upstream link signal.

78. An apparatus in accordance with claim 77, further comprising:
an upstream frequency shifter configured to frequency shift the upstream coverage signal to the upstream link signal to form the upstream link signal.

79. An apparatus comprising:
a coverage receiver configured to receive, from a mobile station, an upstream coverage signal at an upstream coverage frequency within an upstream frequency bandwidth allocated for upstream communication with the mobile station; and
a link transmitter configured to transmit, to a base station, an upstream link signal at an upstream link frequency within a downstream frequency bandwidth allocated for downstream communication with the mobile station, the upstream link signal corresponding to the upstream coverage signal.

80. An apparatus in accordance with claim 79, further comprising:
an upstream frequency shifter configured to frequency shift the upstream coverage signal to the upstream link frequency to form the upstream link signal.

81. An apparatus in accordance with claim 80, further comprising:
a link receiver configured to receive, from the base station, a downstream link signal at a downstream link frequency within the upstream frequency bandwidth; and
a coverage transmitter configured to transmit, to the mobile station, a downstream coverage signal at a downstream coverage frequency within the downstream frequency bandwidth.

82. An apparatus in accordance with claim 81, further comprising:
a downstream frequency shifter configured to frequency shift the downstream link signal to the downstream coverage frequency to form the downstream coverage signal.

83. An apparatus in accordance with claim 82, wherein the downstream coverage frequency and the upstream coverage frequency form one frequency pair of a plurality of frequency pairs, each frequency pair having an upstream frequency and a downstream frequency separated by the frequency difference.

84. A distribution station comprising:
a link receiver configured to receive, from a interface station communicatively connected to a cellular base station, a downstream link signal at a downstream link frequency within an upstream frequency bandwidth allocated to the cellular base station for upstream communication with a mobile station, the downstream link signal corresponding to a downstream coverage signal transmitted from the cellular base station to the interface station,
a downstream frequency shifter configured to frequency shift the downstream link signal to a downstream coverage frequency to form the downstream coverage signal;
a coverage transmitter configured to transmit the downstream coverage signal to the mobile station;
a coverage receiver configured to receive, from the mobile station, an upstream coverage signal at an upstream coverage frequency within the upstream frequency bandwidth;
an upstream frequency shifter configured to frequency shift the upstream coverage signal to an upstream link frequency within a downstream frequency bandwidth allocated to the cellular base station for downstream communication with the mobile station to form an upstream link signal; and
a link transmitter configured to transmit the upstream link signal to the interface station, the upstream link signal corresponding to an upstream coverage signal transmitted from interface station to the cellular base station.

85. An apparatus in accordance with claim 84, wherein the downstream coverage frequency and the upstream coverage frequency are separated by a frequency difference and form one frequency pair of a plurality of frequency pairs, each frequency pair having an upstream frequency and a downstream frequency separated by the frequency difference.

86. An apparatus in accordance with claim 85, wherein the upstream frequency bandwidth comprises a plurality of upstream coverage channels at upstream coverage frequencies and at least one downstream link channel.

87. An apparatus in accordance with claim 85, wherein the downstream frequency bandwidth comprises a plurality of downstream coverage channels at the downstream coverage frequencies and at least one upstream link channel.

88. An apparatus comprising:
a link communication interface configured to communicate, in a first communication direction, with a distribution station using a link frequency within a first frequency bandwidth allocated for communication with a mobile station in a second communication direction; and
a coverage communication interface configured to communicate with a cellular base station in the first communication direction using a coverage frequency within a second frequency bandwidth allocated for communication with a mobile station in the first communication direction.

89. An apparatus in accordance with claim 88, wherein:
the link communication interface is further configured to exchange a link signal at the link frequency with the distribution station; and
the coverage communication interface is further configured to exchange a coverage signal corresponding to the link signal, at the coverage frequency, with the cellular base station.

90. An apparatus in accordance with claim 88, wherein the link communication interface is further configured to communicate, in the second communication direction, with the distribution station using a second link frequency within the second frequency bandwidth allocated for communication with the mobile station in the first communication direction.

91. An apparatus in accordance with claim 88, wherein:
the link communication interface is further configured to communicate, in the second communication direction, with the distribution station by exchanging a second link signal; and
the coverage communication interface is further configured to exchange a second coverage signal with the cellular base station, the second coverage signal corresponding to the second link signal.

92. A apparatus in accordance with claim 91, wherein:
the first communication direction is upstream,
the second communication direction is downstream,
the link frequency is an upstream link frequency;
the first frequency bandwidth is a downstream frequency bandwidth allocated for downstream communication with the mobile station, and
the second frequency bandwidth is an upstream frequency bandwidth allocated for upstream communication with the mobile station.

93. An apparatus in accordance with claim 92, wherein:
the link interface comprises a receiver configured to receive an upstream link signal at the upstream link frequency from the distribution station, and
the coverage interface comprises a transmitter configured to transmit an upstream coverage signal to the cellular base station within the upstream frequency bandwidth, the upstream coverage signal corresponding to the upstream link signal.

94. An apparatus in accordance with claim 93, further comprising:
an upstream frequency shifter configured to frequency shift the upstream link signal to the upstream coverage signal to form the upstream coverage signal.

95. An apparatus in accordance with claim 94, wherein:
the link interface comprises a link transmitter configured to transmit a downstream link signal at the downstream link frequency to the distribution station, and
the coverage interface comprises a coverage receiver configured to receive a downstream coverage signal from the cellular base station within the downstream frequency bandwidth, the downstream link signal corresponding to the downstream coverage signal.

96. An apparatus in accordance with claim 94, further comprising:
a downstream frequency shifter configured to frequency shift the downstream coverage signal to the downstream link frequency to form the downstream link signal.

97. An apparatus in accordance with claim 91, wherein:
the first communication direction is downstream,
the second communication direction is upstream,
the link frequency is downstream link frequency;
the first frequency bandwidth is an upstream frequency bandwidth allocated for upstream communication with the mobile station, and
the second frequency bandwidth is a downstream frequency bandwidth allocated for downstream communication with the mobile station.

98. An apparatus in accordance with claim 97, wherein:
the link interface comprises a link transmitter configured to transmit a downstream link signal at the downstream link frequency to the distribution station, and
the coverage interface comprises a coverage receiver configured to receive a downstream coverage signal from the cellular base station within the downstream frequency bandwidth, the downstream link signal corresponding to the downstream coverage signal.

99. An apparatus in accordance with claim 98, further comprising:
a downstream frequency shifter configured to frequency shift the downstream coverage signal to the downstream link frequency to form the downstream link signal.

100. An apparatus in accordance with claim 97, wherein:
the link interface further comprises a link receiver configured to receive an upstream link signal at the upstream link frequency from the distribution station, and
the coverage interface comprises a coverage transmitter configured to transmit an upstream coverage signal to the cellular base station within the upstream frequency bandwidth, the upstream coverage signal corresponding to the upstream link signal.

101. An apparatus in accordance with claim 92, further comprising:
an upstream frequency shifter configured to frequency shift the upstream link signal to the upstream coverage signal to form the upstream coverage signal.

102. An apparatus comprising:
a link receiver configured to receive, from a distribution station, an upstream link signal at an upstream link frequency within a downstream frequency bandwidth allocated for downstream communication with a mobile station; and
a coverage transmitter configured to transmit, to a cellular base station, an upstream coverage signal at an upstream coverage frequency within an upstream frequency bandwidth allocated for upstream communication with the mobile station, the upstream link signal corresponding to the upstream coverage signal.

103. An apparatus in accordance with claim 102, further comprising:
an upstream frequency shifter configured to frequency shift the upstream link signal to the upstream coverage frequency to form the upstream coverage signal.

104. An apparatus in accordance with claim 103, further comprising:
a link transmitter configured to transmit, to the distribution station, a downstream link signal at a downstream link frequency within the upstream frequency bandwidth; and
a coverage receiver configured to transmit, to the cellular base station, a downstream coverage signal at a downstream coverage frequency within the downstream frequency bandwidth.

105. An apparatus in accordance with claim 104, further comprising:
a downstream frequency shifter configured to frequency shift the downstream coverage signal to the downstream link frequency to form the downstream link signal.

106. An apparatus in accordance with claim 105, wherein the downstream coverage frequency and the upstream coverage frequency form one frequency pair of a plurality of frequency pairs, each frequency pair having an upstream frequency and a downstream frequency separated by the frequency difference.

107. An interface station configured to communicatively connect to a cellular base station, the interface station comprising:
a link transmitter configured to transmit, to a distribution station communicatively connected to a mobile station, a downstream link signal at a downstream link frequency within an upstream frequency bandwidth allocated to the cellular base station for upstream communication with the mobile station, the downstream link signal corresponding to a downstream coverage signal transmitted from the cellular base station to the interface station,
a downstream frequency shifter configured to frequency shift the downstream coverage signal to a downstream link frequency to form the downstream link signal;
a coverage receiver configured to receive the downstream coverage signal from the cellular base station;
a link receiver configured to receive an upstream link signal from the distribution station;
an upstream frequency shifter configured to frequency shift the upstream link signal to an upstream coverage frequency within a downstream frequency bandwidth allocated to the cellular base station for downstream communication with the mobile station to form an upstream coverage signal; and
a coverage transmitter configured to transmit, to the cellular base station, the upstream coverage signal at the upstream coverage frequency within the upstream frequency bandwidth.

108. An apparatus in accordance with claim 107, wherein the downstream coverage frequency and the upstream coverage frequency are separated by a frequency difference and form one frequency pair of a plurality of frequency pairs, each frequency pair having an upstream frequency and a downstream frequency separated by the frequency difference.

109. An apparatus in accordance with claim 108, wherein the upstream frequency bandwidth comprises a plurality of upstream coverage channels at upstream coverage frequencies and at least one downstream link channel.

110. An apparatus in accordance with claim 108, wherein the downstream frequency bandwidth comprises a plurality of downstream coverage channels at the downstream coverage frequencies and at least one upstream link channel.

111. A base station comprising:
a link communication interface configured to communicate, in a first communication direction, with a distribution station using a link frequency within a first frequency bandwidth allocated for communication with a mobile station in a second communication direction.

112. A base station comprising:
a link transmitter configured to transmit, to a distribution station communicatively connected to a mobile station, a downstream link signal at a downstream link frequency within an upstream frequency bandwidth allocated to the cellular base station for upstream communication with the mobile station, the downstream link signal corresponding to a downstream coverage signal transmitted from the distribution station to the mobile station.

113. A base station in accordance with claim 1, further comprising:
a link receiver configured to receive, from the distribution station, an upstream link signal at an upstream link frequency within a downstream frequency bandwidth allocated for downstream communication with the mobile station, the downstream link signal corresponding to a downstream coverage signal transmitted from the distribution station to the mobile unit within the downstream frequency bandwidth.
